(19) United States
(12) Patent Application Publication
(10) Pub. No.: US 2002/0176559 A1
(43) Pub. Date: Nov. 28, 2002

(54) Multimedia for calls on hold

(76) Inventors: John Gerard Adamek, Redmond, WA (US); Eric Harold Henrikson, Redmond, WA (US); Anne Yin-Fee Lee, Naperville, IL (US); Donna Michaels Sand, Redmond, WA (US)

Correspondence Address: Reginald J. Hill, R.J. Hill & Associates, Ltd., Suite 1402, 19 South LaSalle Street, Chicago, IL, 60603, US

(21) Appl. No.: 09/864,545

(22) Filed: May 24, 2001

(51) Int. Cl. H04M 3/42

(52) U.S. Cl. 379/215.01

(57) ABSTRACT

In a multimedia communications system (100) that provides for two-way interactive calls, multimedia data is provided to callers when interactive calls are placed on hold. When a user places a call over the network (202), a determination is made as to whether or not the destination is available. If the destination is not available, the caller is placed on hold (204). While on hold, the user is invited to accept multimedia data, including, for example, a cartoon, interactive game, information, advertisement or the like (206). If the user accepts the invitation (208), bearer channels are set up to send the multimedia data (212). The user may end the multimedia session if the destination becomes available or may continue the multimedia session during and after the voice call to the destination.

### FIELD OF THE INVENTION

The invention generally relates to telecommunications networks, and in particular, to the provision of multimedia data for calls placed over the telecommunications network that are placed on hold.

### BACKGROUND OF THE INVENTION

Wireless communication systems are well known. Wireless communication systems allow mobile radiotelephones to communicate with each other and other networks, such as the Internet and the public telephone network. First and second generation wireless telephone systems are generally constrained in the amount of bandwidth available for communication. This limits capacity and also the types of services that are provided. Third generation wireless systems hold the promise of greater bandwidth, thereby increasing capacity and allowing for enhanced services, such as multimedia services. Proposed third generation wireless communications devices include, in addition to a voice communication interface, capability for communication of data and display of data, including video.

Presently, when voice calls in a telecommunications network are placed on hold due to unavailability of a party, audio may be played to the caller on hold. The caller on hold is not offered a choice of audio. Audio provides only limited entertainment or information for the waiting caller. This often results in the caller dropping from the call or becoming irritated by the audio.

Therefore, a need exist for improved and enhanced communications for a caller on hold.

### SUMMARY OF THE INVENTION

A method is provided for supplying multimedia data to callers whose interactive calls (e.g., voice calls, audio/video calls) are placed on hold. A user terminal sends and a telecommunication network receives a request to establish a call with a destination. If the destination is not available to immediately accept the call, the user terminal is placed on hold. While on hold, a multimedia communication is sent to the user terminal. Preferably, an invitation is sent to the user terminal to accept the multimedia communication while on hold. The multimedia communication is, for example, an interactive game, animation, information, an advertisement, or other communication comprising at least one of voice, audio, video or text. Bearer channels are set up to provide the multimedia communication to the user terminal. After the destination becomes available to accept the call, the user terminal is sent an invitation to terminate the multimedia communication or continue the multimedia communication during or after the interactive call with the destination. The user terminal is coupled to the network via a wired or wireless data link. A telecommunications network for implementing the method is provided.

### BRIEF DESCRIPTION OF THE DRAWINGS

FIG. 1 is a block diagram of a wireless voice-over-IP network that provides multimedia for calls on hold in accordance with the present invention.

FIG. 2 is a flow chart illustrating a method for providing multimedia to calls on hold in accordance with the present invention.

### DESCRIPTION OF THE PREFERRED EMBODIMENTS

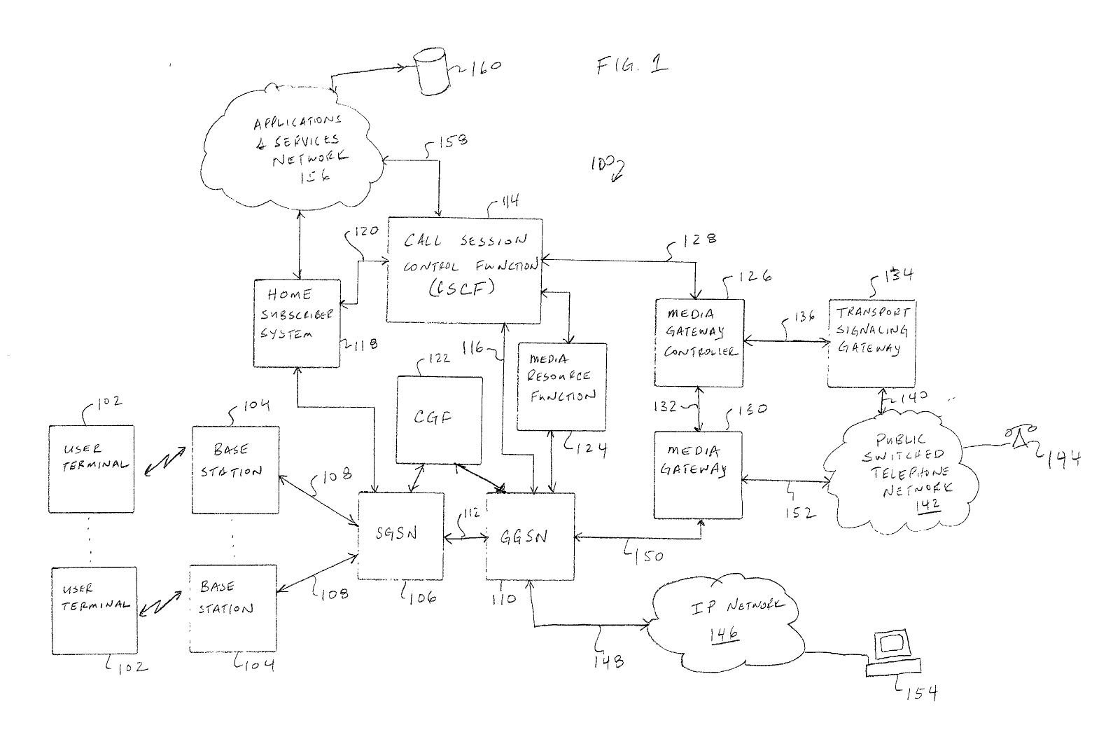

FIG. 1 is a block diagram of a preferred embodiment of a multimedia communications system 100 in accordance with the present invention. Users interact with multimedia communications system 100 via user equipment or user terminals 102. Multimedia communications system 100 includes a third generation wireless system, as defined and proposed by the 3^{rd} Generation Partnership Program, also known as 3GPP (see 3gpp.org). User terminal 102 is typically a mobile device that includes a user interface and an interface for coupling to communications system 100. The user interface of user terminal 102 is typically referred to as terminal equipment and generally includes an audio interface, such as a microphone and speakers, a visual interface, such as a display, and a user input interface, such as a keyboard or touch pad. The interface for coupling to communications system 100 is typically referred to as a mobile terminal and generally includes an over-the-air interface for transmitting and receiving data.

The over-the-air interface of user terminal 102 is used to communicate with base stations 104. In the preferred embodiment, base stations 104 include an over-the-air interface that is complementary to the over-the-air interface of user terminal 102. Most preferably, user terminal 102 and base stations 104 communicate over the air using a packet based protocol.

Multimedia communications system 100 provides users with a variety of options for communication. Users are able to transmit and receive multimedia communications, including audio, voice, video, and all types of data. Multimedia communications system 100 provides access to data networks, such as the Internet, and public telephone networks, including wireless networks.

In the preferred embodiment, the multimedia communications that are directed to and received from users via base stations 104 are coordinated and transferred using a serving GPRS (GSM Packet Radio System) support node (SGSN) 106, a gateway GPRS support node (GGSN) 110, a call session control function (CSCF) 114 and a home subscriber system 118. SGSN 106 coordinates multimedia transmissions to and from base stations 104. SGSN 106 is coupled to GGSN 110 via a data link 112. GGSN 110 interfaces the multimedia communications to and from SGSN 106 to other networks. Call session control function 114 is coupled to GGSN 110 via a data link 116. Call session control function 114 coordinates and executes a signaling protocol used to establish, maintain and control calls or sessions for communications involving user terminal 102. A home subscriber system 118 is coupled to call session control function 114 via a data link 120. Home subscriber system 118 includes subscriber profile information, including information traditionally associated with a home location register for a mobile subscriber.

To facilitate ancillary and support functions within multimedia communications system 100, a charging gateway function (CGF) 122 and a media resource function 124 are provided. Charging gateway function 122 is coupled to SGSN 106 and GGSN 110 to account for packets passing through these elements for accounting, billing and other purposes. Media resource function 124 is coupled to call session control function 114 and to GGSN 110. Media resource function 124 provides resources for conference bridging, tones, announcements and other service functions for communications through GGSN 110.

GGSN 110 couples user terminal 102 to other networks. In particular, GGSN 110 is coupled to an Internet protocol (IP) network 146 via a data link 148. Data link 148 preferably implements a packet-based protocol for transfers to a data network. Data link 148 and IP network 146 provide access to any elements connected to IP network 146, such as, for example, a computer 154. GGSN 110 is also coupled to a media gateway 130 via a data link 150. Media gateway 130 is in turn coupled to a public switched telephone network 142 via a communications link 152. Media gateway 130 converts data received from GGSN 110 to a data protocol acceptable to the public switched telephone network 142. Conversely, media gateway 130 converts data received from public switched telephone network 142 to a protocol acceptable to GGSN 110. Media gateway 130, data link 150, and communications link 152 provide an interface for user terminal 102 to the public switched telephone network 142. By virtue of this connection, user terminal 102 is coupled to elements attached to the public switched telephone network, such as telephone 144.

The signaling and control necessary to interface GGSN 110 with public switched telephone network 142 is controlled and provided by call session control function 110, a media gateway controller 126 and a transport signaling gateway 134. Media gateway controller 126 is coupled to call session control function 114 via a data link 128. Media gateway controller 126 is coupled to control media gateway 130 via data ink 132. Call session control function 114 determines based on a signaling protocol any necessary media gateway resources needed for a particular communication or session. These needs are transmitted to media gateway controller 126, which in turns configures and establishes the necessary resources in media gateway 130 and also provides the necessary signaling to transport signaling gateway 134. The resources in media gateway 130 are configured to transfer the actual (bearer) data between the GGSN 110 and the public switched telephone network 142. Transport signaling gateway 134 converts the signaling protocol from the media gateway controller 136 to a signaling protocol necessary for public switched telephone network 142.

Applications and services are preferably coupled to multimedia communication system 100 for use in interaction with user terminal 102. In particular, call session control function 114 is coupled to an applications and services network 156 via a data link 158. Also, home subscriber system 118 is preferably coupled to application and services network 156. A myriad of services and applications may reside in or be coupled to application services network 156, including database services from a database 160.

In the preferred embodiment, SGSN 106, GGSN 110, CGF 122, media resource function 124, CSCF 114, media gateway controller 126, media gateway 130, and home subscriber system 118 are processor-based apparatus with data link interfaces for coupling together as described above and shown in FIG. 1. These apparatus include one or more processors that execute programs to implement the functionality described herein and generally associated with third generation wireless systems.

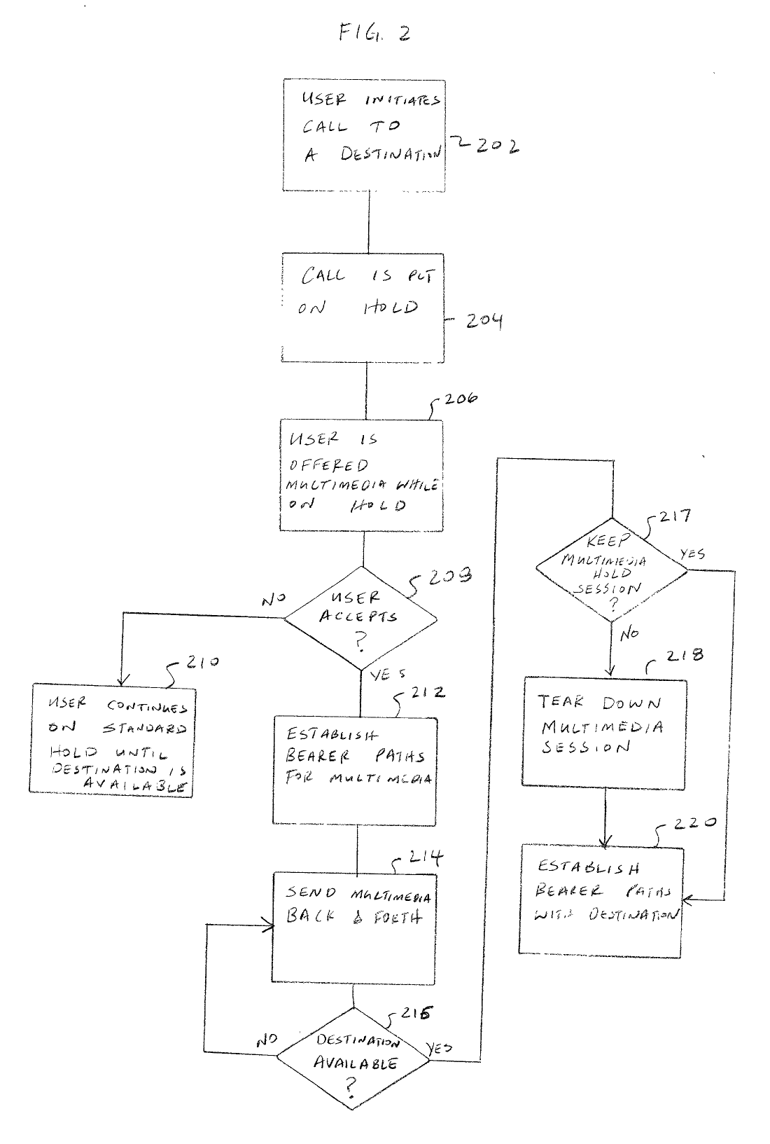

FIG. 2 is a flow chart illustrating a preferred method for providing multimedia data to calls on hold in accordance with the present invention. FIG. 2 is described below with reference to the preferred embodiment described above in FIG. 1.

First a user using user terminal 102 initiates a call to a destination (202). The destination is any communications device coupled to multimedia communications system 100. In the preferred embodiment, user terminal 102 sends a SIP (Session Initiation Protocol) INVITE message (as defined by Internet Engineering Task Force-IETF-RFC 2543) to setup the call. The SIP INVITE message traverses a base station 104, SGSN 106, GGSN 110 and call session control function 114. In one arrangement, call session control function 114 has information regarding the availability of the destination to receive calls. In this case, call session control function 114 can determine that the call is to be put on hold (204) due to the unavailability of the destination. In another arrangement, where call session control function 114 does not have information on the availability of the destination, the SIP INVITE message is transmitted to the destination. In this case the destination itself determines whether it can accept the call or whether the call must be put on hold (204).

Once the call is put on hold (204), the user is offered multimedia communications during the period while the call is on hold (206). In the preferred embodiment, the offering of multimedia services while on hold is accomplished via a session setup including a SIP INVITE message to the user that initiated the original call. The multimedia services offered while on hold may vary. Preferably the multimedia services offered include at least a visual display of an image or text, and are, for example, a video, a cartoon, information, advertising, an interactive game or the like. Most preferably, the user receives options to select from available multimedia services.

If the user does not accept the offer of multimedia services while waiting for the destination (208), then no multimedia sessions are setup and provided and the user continues on hold until the destination becomes available (210). On the other hand, if the user accepts the offer of multimedia services (208), then a bearer path(s) for the requested multimedia is established (212). The multimedia services may be provided by any elements connected to multimedia communications system 100. Preferably, multimedia services and interactive programs are stored and executed by media resource function 124, and elements connected to IP network 146, or from application and services network 156.

After the appropriate bearer paths are setup (212), multimedia services are provided over the bearer paths to the user that awaits the destination (214). The multimedia services continue until the destination becomes available (216). After the destination becomes available (216), then the user awaiting the destination has the option to end the multimedia session or maintain the multimedia session (217). In other words, after the user is alerted that the destination is available, the user may decide to end the multimedia session or the user may decide to maintain the session to continue during the call or to continue after the communications with the destination are complete. If the user decides not to keep the multimedia session, then the multimedia session is terminated and torn down (218). In any event, bearer paths are established between the user and the destination for the original call after the destination becomes available (220).

Although the preferred method above describes a call initiated by a user using user terminal 102, any user that has a communication device capable of accepting a particular type of multimedia data may receive multimedia data while on hold. Also, the destination need not be multimedia enabled or even directly coupled to multimedia communications system 100, since the multimedia services may be provided from any element(s) coupled to multimedia communications system 100.

In an alternate embodiment of the invention, steps 206 and 208 are modified such that the acceptance of multimedia while on hold is automated. In one case, prior to placing the call the user selects an option to automatically accept all offers of multimedia while on hold. This option is alternatively set in the user terminal or in an element of multimedia communications system 100. In another case, the multimedia session is transmitted to the user automatically, that is, without user acceptance, after the call is placed on hold.

As discussed above, communications with a particular destination are enhanced by providing multimedia data to a caller that is unable to immediately reach a destination. The multimedia data provided during a period while a caller is on hold includes audio, video, text and other data that is combined to form services such as interactive games, video clips, audio clips, cartoons, information, advertisements and any other data. The provision of multimedia data while on hold enhances communications and offers the ability to provide alternative services.

Whereas the present invention has been described with respect to specific embodiments thereof, it will be understood that various changes and modifications will be suggested to one skilled in the art and it is intended that the invention encompass such changes and modifications as fall within the scope of the appended claims.

1. A method for providing multimedia data to calls on hold, the method comprising the steps of:
receiving a request from a user terminal to establish a call with a destination;
determining that the destination is not available to immediately accept the call;
placing the user terminal on hold;
sending an invitation to the user terminal to accept a multimedia communication while on hold; and
if an acceptance to the invitation is received, providing the multimedia communication to the user terminal.

2. The method of claim 1 wherein the user terminal transmits the request over one of a wired or a wireless network.

3. The method of claim 1 wherein a call session control function determines whether the destination is available.

4. The method of claim 1 wherein the destination determines whether the destination is available.

5. The method of claim 1 wherein the multimedia communication includes at least one of video data, audio data, voice data and text.

6. The method of claim 1 wherein the step of providing the multimedia communication to the user terminal further includes transmitting the multimedia communication over a packet-based network.

7. The method of claim 1 wherein the step of sending an invitation further includes providing options to the user terminal for a type of the multimedia communication.

8. The method of claim 1 further comprising the step of:
sending an invitation to the user terminal to terminate the multimedia communication when the destination becomes available.

9. The method of claim 8 further comprising the step of:
establishing a bearer path between the user terminal and the destination when the destination becomes available.

10. The method of claim 9 wherein the call includes two-way voice communication.

11. A telecommunications network that provides multimedia data to callers who place calls over the telecommunications network while the calls are on hold, the telecommunications network comprising:
means for receiving a request from a user terminal to establish a call with a destination;
means for determining that the destination is not available to immediately accept the call;
means for placing the user terminal on hold;
means for sending an invitation to the user terminal to accept a multimedia communication while on hold; and
means for providing the multimedia communication to the user terminal if the invitation is accepted by the user terminal.

12. The network of claim 11 wherein the user terminal transmits the request over one of a wired or a wireless data link.

13. The network of claim 11 wherein the means for determining that the destination is not available includes a call session control function that determines whether the destination is not available.

14. The network of claim 11 wherein the destination determines whether the destination is available.

15. The network of claim 11 wherein the multimedia communication includes at least one of video data, audio data, voice data and text.

16. The network of claim 11 wherein the means for providing the multimedia communication to the user terminal includes means for transmitting the multimedia communication over a packet-based network.

17. The network of claim 11 wherein the means for sending an invitation further includes means for providing options to the user terminal for a type of the multimedia communication.

18. The network of claim 11 further comprising:
means for sending an invitation to the user terminal to terminate the multimedia communication when the destination becomes available.

19. The network of claim 18 further comprising:
means for establishing a bearer path between the user terminal and the destination when the destination becomes available.

20. The network of claim 19 wherein the call includes two-way voice communication.

21. A method for providing multimedia data to calls on hold, the method comprising the steps of:
receiving a request from a user terminal to establish a call with a destination;
determining that the destination is not available to immediately accept the call;
placing the user terminal on hold;
providing a multimedia communication to the user terminal while the user terminal is on hold, the multimedia communication including at least a visual display of data.

22. The method of claim 21 wherein the user terminal transmits the request over one of a wired or a wireless network.

23. The method of claim 21 wherein a call session control function determines whether the destination is available.

24. The method of claim 21 wherein the destination determines whether the destination is available.

25. The method of claim 21 wherein the step of providing the multimedia communication to the user terminal further includes transmitting the multimedia communication over a packet-based network.

26. The method of claim 21 further comprising the step of:
establishing a bearer path between the user terminal and the destination when the destination becomes available.

27. The method of claim 21 wherein the call includes two-way voice communication.
